(19) United States
(12) Patent Application Publication
(10) Pub. No.: US 2026/0001087 A1
(43) Pub. Date: Jan. 1, 2026

(54) PROCESS AND COMPOSITION FOR TREATING AN ORE

(71) Applicant: Hexion Inc., Columbus, OH (US)

(72) Inventors: Robert Bruce CURRIE, Stafford, TX (US); Anjennee Jessica Gajadhur, Brimbank (AU); Christopher COBBLEDICK, Caroline Springs (AU)

(21) Appl. No.: 19/131,630

(22) PCT Filed: Nov. 2, 2023
(86) PCT No.: PCT/US2023/036702

§ 371 Date: May 21, 2025

(30) Foreign Application Priority Data
Nov. 21, 2022 (AU) 2022903509

(51) Int. Cl. B03D 1/008; B03D 1/006; C01D 15/02; C01D 15/08

(52) U.S. Cl. CPC B03D 1/008; B03D 1/006; C01D 15/02; C01D 15/08; B03D 2201/02; B03D 2203/04

(57) ABSTRACT

Provided herein are processes for treating a metal ore containing a flotable mineral involving subjecting an ore to flotation and separating a fraction enriched in the flotable mineral from a fraction containing waste ore components. Also provided herein are flotation collector compositions useful in the above processes, and additive compositions and kits for producing the flotation collector compositions.

### CROSS-REFERENCE TO RELATED APPLICATION

The present application claims priority from Australian provisional patent application no. 2022903509 filed on 21 Nov. 2022, the entire contents of which are incorporated herein by this cross-reference.

### FIELD

The present disclosure relates generally to the field of mineral processing, and more particularly to processes for treating an ore containing a flotable mineral involving subjecting an ore to flotation and separating a fraction enriched in the flotable mineral from a fraction containing waste ore components. The disclosure also relates to flotation collector compositions useful in such processes, and additive compositions and kits for producing the flotation collector compositions.

### BACKGROUND

Global demand for various metals and minerals has been increasing in recent times. For example, in the case of lithium, there has been expanding need for lithium in applications such as heat-resistant glass and ceramics, lithium grease lubricants, flux additives for iron, steel and aluminium production, lithium batteries, and lithium-ion batteries. The demand for rare earth metals like lanthanum and cerium is also anticipated to increase as a result of a number of causes, including the development of the electronics and automotive industries. For example, lanthanum is used in large quantities in nickel metal hydride (NiMH) rechargeable batteries for hybrid automobiles, as a petroleum cracking catalyst and as an additive to make nodular cast iron and as an additive in steel. Cerium compounds have a number of practical applications, for example, the dioxide is employed in the optics industry for fine polishing of glass, as a decolorizer in glass manufacturing, in petroleum cracking catalysts, and as a three-way automotive emission catalyst that makes use of its dual valence (3+/4+) characteristics.

To meet growing demand, especially for electric vehicle batteries, more efficient means of producing high-purity lithium and rare earth metals with reduced effort, cost and environmental impact are required.

One method of obtaining minerals from ore is flotation. Such processes involve contacting particles with water in the presence of air bubbles and suitable chemicals, resulting in binding of chemicals to the surface of mineral particles rendering them hydrophobic, such that they are carried to the upper surface by the air bubbles, and froth enriched in the mineral particles can be separated from unwanted minerals. In the case of lithium, flotation is the most widely used beneficiation process. Silicate ores are most widely processed using the flotation method. In the case of rare earth metals like lanthanum and cerium, although several techniques are available for separating ores containing these metals from gangue minerals such as bastnäsite and monzanite, including re-election, magnetic separation, and electric separation, froth flotation is becoming the dominant technique. Bastnaesite is a rare earth fluorocarbonate mineral containing primarily cerium and lanthanum and is one of the most abundant sources of rare earths in the United States. Monazite is a rare phosphate mineral which typically contains about 45-48% cerium, about 24% lanthanum, about 17% neodymium, about 5% praseodymium, and minor quantities of samarium, gadolinium, and yttrium, and usually occurs in small, isolated grains, as an accessory mineral in igneous and metamorphic rocks such as granite, pegmatite, schist, and gneiss.

A number of chemical materials have been proposed for use in flotation processes over the years to assist in improving recovery of desired metal-containing minerals. These can provide improved beneficiation properties such as increased grade and recovery of the final concentrate. In more recent times, stricter regulation as well as complex and low-quality feeds paired with an increased demand for high-grade ore concentrates has posed challenges for the mining sector. Some existing chemical compositions used in flotation can have low specificity that lead to sub-optimal grades and recoveries, may have limitations in terms of their capability to perform sufficiently in groundwater, or may require dosing at high dose rates.

Progress in providing high-performing chemical compositions (known as flotation collector compositions) for use in obtaining lithium-containing and other minerals has proven challenging. There is a need for collector compositions capable of meeting the quality and specifications of mining products. In addition, factors including environmental requirements, logistic challenges, raw material sustainability and variability in plant technical designs and feed chemical compositions need to be taken into account.

It would be desirable to provide further flotation processes and compositions for use in such processes which facilitate recovery of flotable minerals.

### SUMMARY

The present inventors have identified flotation collector compositions which provide for good recovery of flotable minerals such as the lithium-containing mineral spodumene in flotation processes. It has been found that the compositions provide for good recovery of spodumene from ores and/or good grades of spodumene, and provide for good performance even when dosed at relatively low levels.

Thus, in one aspect, there is provided a process for treating an ore, comprising:
subjecting an ore containing a flotable mineral to flotation; and subsequently
separating a first fraction enriched in the flotable mineral from a second fraction containing waste ore components,
wherein flotation is carried out in the presence of:
   i) a fatty acid comprising one or more of oleic acid, linoleic acid and palmitic acid; and
   ii) an ether carboxylic acid surfactant, and/or a fatty acid alkyl ester.

In some embodiments, the fatty acid is a tall oil fatty acid or tall oil fatty acid mixture.

In some embodiments, the tall oil fatty acid or tall oil fatty acid mixture has one or more of the following properties:
an acid value in the range of from 185 to 195 mg KOH/g; and
a rosin acid content of up to 4 wt %.

In some embodiments, flotation is carried out in the presence of an ether carboxylic acid surfactant.

In some embodiments, the ether carboxylic acid surfactant is an alkyl ether carboxylic acid surfactant.

In some embodiments, the alkyl ether carboxylic acid surfactant is a polyoxyethylene alkyl ether carboxylic acid surfactant.

In some embodiments, the polyoxyethylene alkyl ether carboxylic acid or salt thereof is of the formula:

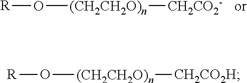

R is a C₆-20 alkyl group; and
n is an integer of from 2 to 100.

In some embodiments, the surfactant is selected from the group consisting of Akypo RLM 25, Emulsogen CLA020, Emulsogen CLA030, and AEC-25.

In some embodiments, flotation is carried out in the presence of a fatty acid alkyl ester.

In some embodiments, the fatty acid alkyl ester is a biodiesel fatty acid alkyl ester or biodiesel fatty acid alkyl ester mixture.

In some embodiments, the fatty acid alkyl ester is methyl oleate.

In some embodiments, the fatty acid and the ether carboxylic acid surfactant are added together in the form of a flotation collector composition.

In some embodiments, the flotation collector composition comprises from about 50 to about 90 wt % fatty acid, optionally from about 60 to about 80 wt %, optionally about 70 wt %.

In some embodiments, the flotation collector composition comprises from about 5 to about 30 wt % ether carboxylic acid surfactant, optionally about 15 wt %.

In some embodiments, the weight ratio of fatty acid to ether carboxylic acid surfactant is in the range of from about 70:30 to about 95:5, optionally about 70:15.

In some embodiments, flotation is carried out in the presence of a fatty acid comprising one or more of oleic acid, linoleic acid and palmitic acid; an ether carboxylic acid surfactant; and a fatty acid alkyl ester.

In some embodiments, the fatty acid, ether carboxylic acid surfactant and fatty acid alkyl ester are added together in the form of a flotation collector composition.

In some embodiments, the flotation collector composition comprises from about 5 to about 30 wt % fatty acid alkyl ester, optionally about 15 wt %.

In some embodiments, the weight ratio of fatty acid to fatty acid alkyl ester is in the range of from about 70:30 to about 95:5, optionally about 70:15.

In some embodiments, the weight ratio of fatty acid to ether carboxylic acid surfactant to fatty acid alkyl ester is about 70:15:15.

In some embodiments, flotation is carried out in the presence of a frother.

In some embodiments, the frother is an aliphatic alcohol or a polyether, optionally wherein the frother is methyl isobutyl carbinol (MIBC), 4-methyl-2-pentanol, or polypropylene glycol.

In some embodiments, the fatty acid, ether carboxylic acid surfactant and/or fatty acid alkyl ester, and frother, are added together in the form of a flotation collector composition, optionally wherein the flotation collector composition comprises from about 1 to about 8 wt % frother, optionally about 4 wt %.

In some embodiments, the flotable mineral is a metal-containing mineral.

In some embodiments, the metal-containing mineral is a lithium-containing mineral.

In some embodiments, the metal-containing mineral is a metal silicate.

In some embodiments, the metal-containing mineral is spodumene.

In some embodiments, the flotable mineral is a rare earth metal-containing mineral, optionally wherein the rare earth metal-containing mineral is a lanthanum, neodymium, cerium, praseodymium, or niobium-containing mineral.

In some embodiments, the rare earth metal-containing mineral is a metal silicate, metal carbonate, metal phosphate, or metal oxide, optionally wherein the rare earth metal-containing mineral is monazite, bastnasite, columbite, pyrochlore, loparite or dizanalite.

In some embodiments, the flotation collector composition is added at a dosing rate in the range of from about 250 to about 600 grams per tonne of dry metal ore, optionally from about 400 to 500 grams per tonne of dry metal ore.

In some embodiments, wherein, following separation of the first fraction from the second fraction, the first fraction is subjected to one or more further processing and/or purification steps.

In some embodiments, wherein, following separation of the first fraction from the second fraction, the first fraction is subjected to a further flotation and separation step to produce a fraction which is further enriched in the flotable mineral, wherein the further flotation step is carried out in the presence of:
i) a fatty acid comprising one or more of oleic acid, linoleic acid and palmitic acid; and
ii) an ether carboxylic acid surfactant, and/or a fatty acid alkyl ester.

In some embodiments, the further flotation step is carried out in the presence of a fatty acid comprising one or more of oleic acid, linoleic acid and palmitic acid; an ether carboxylic acid surfactant; and a fatty acid alkyl ester.

In some embodiments, the further flotation step is carried out in the presence of a frother.

In some embodiments, the frother is an aliphatic alcohol or a polyether, optionally wherein the frother is methyl isobutyl carbinol (MIBC), 4-methyl-2-pentanol, or polypropylene glycol.

In some embodiments, one or more fractions enriched in the metal-containing mineral are filtered and dried.

In another aspect, there is provided a flotable mineral obtained by a process as defined herein.

In another aspect, there is provided a flotable mineral obtained by a process as defined herein, wherein the flotable mineral is spodumene.

In some embodiments, the flotable mineral is spodumene and, following separation of the fraction enriched in spodumene, lithium present in spodumene is obtained by conversion of the spodumene into lithium carbonate or lithium hydroxide.

In another aspect, there is provided lithium carbonate or lithium hydroxide obtained by a process as defined herein.

In another aspect, there is provided a flotation collector composition comprising:
i) a fatty acid comprising one or more of oleic acid, linoleic acid and palmitic acid; and
ii) an ether carboxylic acid surfactant, and/or a fatty acid alkyl ester.

In some embodiments, the fatty acid is a tall oil fatty acid or tall oil fatty acid mixture.

In some embodiments, the tall oil fatty acid or tall oil fatty acid mixture has one or more of the following properties:
an acid value in the range of from 185 to 195 mg KOH/g; and
a rosin acid content of up to 4 wt %.

In some embodiments, the flotation collector composition comprises an ether carboxylic acid surfactant.

In some embodiments, the ether carboxylic acid surfactant is an alkyl ether carboxylic acid surfactant.

In some embodiments, the alkyl ether carboxylic acid surfactant is a polyoxyethylene alkyl ether carboxylic acid surfactant.

In some embodiments, the polyoxyethylene alkyl ether carboxylic acid or salt thereof is of the formula:

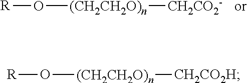

R is a C₆₋₂₀ alkyl group; and
n is an integer of from 2 to 100.

In some embodiments, the surfactant is selected from the group consisting of Akypo RLM 25, Emulsogen CLA020, Emulsogen CLA030, and AEC-25.

In some embodiments, the flotation collector composition comprises a fatty acid alkyl ester.

In some embodiments, the fatty acid alkyl ester is a biodiesel fatty acid alkyl ester or biodiesel fatty acid alkyl ester mixture.

In some embodiments, the fatty acid alkyl ester is methyl oleate.

In some embodiments, the flotation collector composition comprises a fatty acid comprising one or more of oleic acid, linoleic acid and palmitic acid; an ether carboxylic acid surfactant; and a fatty acid alkyl ester.

In some embodiments, the flotation collector composition comprises from about 50 to about 90 wt % fatty acid, optionally from about 60 to about 80 wt %, optionally about 70 wt %.

In some embodiments, the flotation collector composition comprises from about 5 to about 30 wt % ether carboxylic acid surfactant, optionally about 15 wt %.

In some embodiments, the weight ratio of fatty acid to ether carboxylic acid surfactant is in the range of from about 70:30 to about 95:5, optionally about 70:15.

In some embodiments, the flotation collector composition comprises from about 5 to about 30 wt % fatty acid alkyl ester, optionally about 15 wt %.

In some embodiments, the weight ratio of fatty acid to fatty acid alkyl ester is in the range of from about 70:30 to about 95:5, optionally about 70:15.

In some embodiments, the weight ratio of fatty acid to ether carboxylic acid surfactant to fatty acid alkyl ester is about 70:15:15.

In some embodiments, the flotation collector composition comprises a frother, optionally wherein the flotation collector composition comprises from about 1 to about 8 wt % frother, or about 4 wt %.

In some embodiments, the frother is an aliphatic alcohol or a polyether, optionally wherein the frother is methyl isobutyl carbinol (MIBC), 4-methyl-2-pentanol, or polypropylene glycol.

In another aspect, there is provided an additive composition for producing a flotation collector composition, comprising:
an ether carboxylic acid surfactant; and
a fatty acid alkyl ester.

In some embodiments, the ether carboxylic acid surfactant is an alkyl ether carboxylic acid surfactant.

In some embodiments, the alkyl ether carboxylic acid surfactant is a polyoxyethylene alkyl ether carboxylic acid surfactant.

In some embodiments, the polyoxyethylene alkyl ether carboxylic acid or salt thereof is of the formula:

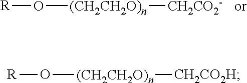

R is a C₆₋₂₀ alkyl group; and
n is an integer of from 2 to 100.

In some embodiments, the surfactant is selected from the group consisting of Akypo RLM 25, Emulsogen CLA020, Emulsogen CLA030, and AEC-25.

In some embodiments, the fatty acid alkyl ester is a biodiesel fatty acid alkyl ester or biodiesel fatty acid alkyl ester mixture.

In some embodiments, the fatty acid alkyl ester is methyl oleate.

In another aspect, there is provided a kit of parts for producing a flotation collector composition, comprising:
a) a fatty acid comprising one or more of oleic acid, linoleic acid and palmitic acid; and one or both of
b) an ether carboxylic acid surfactant; and
b1) a fatty acid alkyl ester.

In some embodiments, the fatty acid ester is a tall oil fatty acid or tall oil fatty acid mixture.

In some embodiments, the tall oil fatty acid or tall oil fatty acid mixture has one or more of the following properties:
an acid value in the range of from 185 to 195 mg KOH/g; and
a rosin acid content of up to 4 wt %.

In some embodiments, the kit comprises an ether carboxylic acid surfactant.

In some embodiments, the ether carboxylic acid surfactant is an alkyl ether carboxylic acid surfactant.

In some embodiments, the alkyl ether carboxylic acid surfactant is a polyoxyethylene alkyl ether carboxylic acid surfactant.

In some embodiments, the polyoxyethylene alkyl ether carboxylic acid or salt thereof is of the formula:

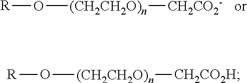

R is a C₆₋₂₀ alkyl group; and
n is an integer of from 2 to 100.

In some embodiments, the surfactant is selected from the group consisting of Akypo RLM 25, Emulsogen CLA020, Emulsogen CLA030, and AEC-25.

In some embodiments, the kit comprises a fatty acid alkyl ester.

In some embodiments, the fatty acid alkyl ester is a biodiesel fatty acid alkyl ester or biodiesel fatty acid alkyl ester mixture.

In some embodiments, the fatty acid alkyl ester is methyl oleate.

In some embodiments, the kit comprises a) a fatty acid comprising one or more of oleic acid, linoleic acid and palmitic acid; b) an ether carboxylic acid surfactant; and b1) a fatty acid alkyl ester.

In some embodiments, the kit comprises a frother.

### BRIEF DESCRIPTION OF THE DRAWINGS

FIG. 1 shows a schematic of a three stage cleaner flotation process used in Example 2 of the present disclosure which was used to compare the effectiveness of Example Compositions A and B.

FIG. 2 shows a graph of LiO₂ cumulative recovery/grade of collector compositions A and B.

FIG. 3 shows a schematic of a rougher only design used in the flotation experiments of Example 3 of the present disclosure.

FIG. 4 provides a graphical representation of Li cumulative grade (%) vs Li cumulative recovery (%) from the flotation experiments of Example 3 using the tall oil fatty acid FA2 as standard compared to Composition C.

FIG. 5 provides a graphical representation of Li cumulative recovery (%) vs time(s) from the flotation experiments of Example 3 using the tall oil fatty acid FA2 as standard compared to Composition C.

FIG. 6 shows a schematic of a rougher and cleaner design used in the flotation experiments of Example 4 of the present disclosure.

FIG. 7 provides a graphical representation of Li cumulative grade (%) vs Li cumulative recovery rougher and cleaner (%) from the flotation experiments of Example 4 using the tall oil fatty acid FA2 as standard compared to Composition C.

### DETAILED DESCRIPTION

### Definitions

Unless specifically defined otherwise, all technical and scientific terms used herein shall be taken to have the same meaning as commonly understood by one of ordinary skill in the art.

The present disclosure refers to the entire contents of certain documents being incorporated herein by reference. In the event of any inconsistent teaching between the teaching of the present disclosure and the contents of those documents, the teaching of the present disclosure takes precedence.

It is to be understood that if any prior art publication is referred to herein, such reference does not constitute an admission that the publication forms a part of the common general knowledge in the art.

As used herein, the term “and/or”, e.g., “X and/or Y” shall be understood to mean either “X and Y” or “X or Y” and shall be taken to provide explicit support for both meanings or for either meaning.

As used herein, the term about, unless stated to the contrary, refers to +/−10%, of the designated value.

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Unless otherwise indicated, terms such as “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

As used herein, the word “comprise” and other forms of the word, such as “comprising” and “comprises,” means including but not limited to, and is not intended to exclude, for example, other additives, components, integers, or steps.

The disclosure also includes all of the steps, features, compositions and compounds referred to or indicated in this specification, individually or collectively, and any and all combinations or any two or more of said steps or features.

Each embodiment of the present disclosure described herein is to be applied mutatis mutandis to each and every other embodiment unless specifically stated otherwise, or required otherwise by context.

### Process for Treating Ore

In one aspect, there is provided a process for treating an ore, comprising:
subjecting an ore containing a flotable mineral to flotation; and subsequently
separating a first fraction enriched in the flotable mineral from a second fraction containing waste ore components,
wherein flotation is carried out in the presence of:
   i) a fatty acid comprising one or more of oleic acid, linoleic acid and palmitic acid; and
   ii) an ether carboxylic acid surfactant, and/or a fatty acid alkyl ester.

The process involves subjecting an ore containing a flotable mineral to flotation, in the presence of a fatty acid and an ether carboxylic acid surfactant and/or a fatty acid alkyl ester.

Flotation (also known as froth flotation) is a process for physically separating particles of ore components. Particles of ore components (i.e. including the desired flotable mineral and other components of metal ore), are introduced into a liquid medium (typically water) in the presence of the fatty acid, and the ether carboxylic acid surfactant and/or fatty acid alkyl ester. Gas (e.g. air) bubbles are passed through the liquid medium. Particles of the desired component (i.e. the flotable mineral) are preferentially carried to the top of the liquid medium, whereas other ore components are less likely to be carried to the surface, due to difference in properties. Chemicals added to the flotation medium (e.g. the fatty acid) are understood to bind to the surface of the flotable mineral particles increasing their hydrophobicity, improving their ability to adhere to the gas bubbles and be carried to the top of the liquid medium. A froth enriched in the desired component (e.g. the flotable mineral) can then be collected and removed from the remainder of the liquid medium, thereby separating a fraction enriched in the flotable mineral from other ore components.

Whilst in some embodiments, a single step flotation process can be carried out, in some embodiments a multi-step flotation process is utilised.

In embodiments where a multi-step flotation process is used, the first flotation step can be referred to as ‘roughing’ or a ‘rougher’ step. Whilst the step can be carried out in any manner desired by a skilled person, typically the flotation conditions are adapted to recover the maximum amount of the flotable mineral as is practical, with lower emphasis on the grade of the concentrate produced.

In embodiments where a multi-step flotation process is used, a latter flotation step can be referred to as a ‘cleaner’ step. Again, whilst such a step can be carried out in any manner desired by a skilled person, typically the flotation conditions are adapted to achieve a high grade of flotable mineral.

Accordingly, in some embodiments, following separation of the first fraction from the second fraction, the first fraction is subjected to a further flotation and separation step to produce a fraction which is further enriched in the flotable mineral, wherein the further flotation step is carried out in the presence of:
i) a fatty acid comprising one or more of oleic acid, linoleic acid and palmitic acid; and
ii) an ether carboxylic acid surfactant, and/or a fatty acid alkyl ester.

In some embodiments, the process can also include a ‘scavenger’ step, which for example may be carried out to recover additional flotable mineral from the waste ore fraction obtained following a flotation step (e.g. a rougher step). The waste ore fraction, which still contains some of the desired flotable mineral, is subjected to a further flotation step as described above. Similarly, a cleaner step may also be followed by a scavenging step performed on the cleaner tailings.

Accordingly, in some embodiments, following separation of the first fraction from the second fraction, the second fraction is subjected to a further flotation and separation step to produce a fraction which is enriched in the flotable mineral, wherein the further flotation step is carried out in the presence of:
i) a fatty acid comprising one or more of oleic acid, linoleic acid and palmitic acid; and
ii) an ether carboxylic acid surfactant, and/or a fatty acid alkyl ester.

In some embodiments, the further flotation step is carried out in the presence of a frother. In some embodiments, the frother is an aliphatic alcohol or a polyether. In some embodiments, the frother is methyl isobutyl carbinol (MIBC), 4-methyl-2-pentanol, or polypropylene glycol.

The feedstock for the process is an ore. The ore contains the flotable mineral of interest.

In some embodiments, the ore is a metal ore. Suitable metal ores are those containing a flotable metal-containing mineral. In some embodiments, the metal-containing mineral is a metal silicate. In some embodiments, the metal ore contains a lithium-containing mineral. In some embodiments, the metal ore contains a lithium silicate. In some embodiments, the metal ore contains spodumene. The metal-containing mineral spodumene, also called triphane, is a lithium aluminium silicate mineral (LiAlSi₂O₆) in the pyroxene family, and is a good source of lithium. In some embodiments, the metal ore contains a rare earth metal, e.g. it may contain a rare earth metal-containing mineral. In some embodiments the rare earth metal is selected from the group consisting of scandium, yttrium, lanthanum, cerium, praseodymium, neodymium, promethium, samarium, europium, gadolinium, terbium, dysprosium, holmium, erbium, thulium, ytterbium, niobium and lutetium. In some embodiments the rare earth metal is selected from the group consisting of lanthanum, neodymium, cerium, praseodymium, and niobium. In some embodiments, the metal ore contains a rare earth metal-containing mineral selected from a carbonate, phosphate, silicate, and an oxide. In some embodiments, the metal ore contains a rare earth metal-containing mineral selected from the group consisting of aeschynite, euxenite, fergusonite, samarskite, ancylite, bastnasite, parasite, snychisite, tengerite, britholite, florencite, monazite, xenotime, allanite, kainosite and thalenite. In some embodiments, the metal ore contains monazite, bastnasite, columbite pyrochlore, loparite and/or dizanalite.

In some embodiments, the ore is a non-metallic ore. Suitable non-metallic ores are those containing a flotable non-metallic mineral.

In some embodiments the flotable mineral is selected from the group consisting of a phosphate, sulphate, rare earth element mineral, barite, fluorite, feldspar, potash, fluorspar, magnesite, Scheelite, celestite, anglesite, alunite, bauxite, gypsum, kainite, biotite, calcite, dolomite, albite, orthoclase, microcline, anhydrite, columbite, tantalite, pyrochlore, apatite, cassiterite, wolframite, rutile, ilmenite, hematite and kaolin.

In some embodiments, the flotable mineral is a rare earth element mineral, such as for example monazite, bastnasite, columbite pyrochlore, loparite or dizanalite.

In some embodiments, the flotable mineral is a feldspar. In some embodiments the flotable mineral is a phosphate. In some embodiments, the flotable mineral is a rare earth element mineral. In some embodiments, the flotable mineral is a rare earth element phosphate, carbonate, silicate or oxide. In some embodiments, the flotable mineral is a rare earth element phosphate. In some embodiments, the flotable mineral is a sulphate. In some embodiments, the flotable mineral is a metal sulfate.

Prior to carrying out flotation step, the ore is typically treated to produce particles. Any suitable method of producing particles of appropriate size may be used, for example a crusher or series of crushers may be utilised, or a suitable mill. The particles may for example be passed through one or more screens or sieves.

In some embodiments, the ore introduced into the flotation step has an average (e.g. mean, median, mode) particle diameter in the range of from 20 to 500 μm, or 50 to 300 μm, or 100 to 200 μm. In some embodiments, the ore introduced into the flotation step has an average (e.g. mean, median, mode) particle diameter of about 50, about 60, about 70, about 80, about 90, about 100, about 110, about 120, about 130, about 140, about 150, about 160, about 170, about 180, about 190, about 200, about 210 about 220, about 230, about 240, about 250, about 260, about 270, about 280, about 290, or about 300 μm. Any suitable method may be used to determine mean particle diameter, for example such as sieve analysis.

Where a multi-step process is used, e.g. containing rougher and cleaner steps, in some embodiments the ore may be subject to a first particle size reduction step prior to the first flotation step, and then the fraction enriched in flotable mineral may be subjected to a second particle size reduction step to further reduce particle size.

The amount of flotable mineral recovered may for example be expressed as a weight proportion or percentage of the total amount of flotable mineral present in the ore. The grade of the flotable mineral recovered may for example be expressed as a weight proportion or percentage of the recovered fraction. A number of factors may affect the grade or recovery of flotable mineral, such as the particle size of the ore introduced into the flotation step, and the time for which flotation is carried out prior to separation of the fraction enriched in the flotable mineral.

Flotation may be carried out for any suitable time period. In some embodiments, the flotation step is carried out for up to an hour, or up to 30 minutes, or up to 15 minutes, or up to 10 minutes, or up to 5 minutes or up to 4 minutes, or up to 3 minutes, or up to 2 minutes. In some embodiments, the flotation step is carried out for a period in the range of from 30 seconds to 15 minutes, or from 30 seconds to 10 minutes, or from 30 seconds to 5 minutes, or from 1 to 5 minutes, or from 1 to 4 minutes or from 1 to 3 minutes, or from 1 to 2 minutes.

Flotation may be carried out at any suitable temperature, for example at a temperature in the range of from 10° C. to 50° C., or from 20° C. to 40° C. In some embodiments, flotation is carried out at ambient temperature.

Any suitable source of gas bubbles may be utilised. For example, electrolytic bubble generation, pressure dissolution or mechanical air induction may be used. Bubble size may also be controlled as desired, for example by use of appropriate bubble generation equipment and conditions.

Flotation may be carried out at any suitable pH, for example at a pH in the range of from 5 to 11, or from 6 to 10, or from 7 to 9, or about 8. If desired, a suitable acid, base and/or buffer may be added to the liquid medium to achieve and/or maintain the desired pH. In some embodiments, sodium carbonate is added.

Any suitable means of separating the fraction enriched in the flotable mineral (i.e. the top froth fraction) may be utilised, such as for example by collection of the top fraction into a suitable container such as a tank or tanks. Flotation is carried out in the presence of a fatty acid, an ether carboxylic acid surfactant and/or a fatty acid alkyl ester. Such chemical compositions facilitate good recovery of flotable mineral (such as spodumene) under a range of conditions, including using hard water and soft water. This may be advantageous for mine sites where water purification systems are not present.

The flotation step is carried out in the presence of a fatty acid comprising one or more of oleic acid, linoleic acid and palmitic acid. A single fatty acid may be used, or a mixture of multiple fatty acids, as long as that mixture includes at least one of oleic acid, linoleic acid and palmitic acid. Advantageously, example collector compositions containing the fatty acid, demonstrate good recovery properties for spodumene.

Without wishing to be bound by any particular theory, it is understood that the fatty acids form a layer on the particle surface that essentially makes a thin film of non-polar hydrophobic hydrocarbons, which can facilitate adherence of the particle to gas bubbles.

In some embodiments, the fatty acid is or comprises oleic acid. In some embodiments, the fatty acid is or comprises linoleic acid. In some embodiments, the fatty acid is or comprises palmitic acid.

The fatty acid or fatty acid mixture may be derived from any suitable source. Examples include almond oil, beef tallow, butterfat, canola oil, cocoa butter, cod liver oil, coconut oil, corn oil (maize oil), cottonseed oil, flaxseed oil, grape seed oil, illipe, lard, for example, from pork fat, olive oil, palm oil, palm olein, palm kernel oil, peanut oil, safflower oil, sesame oil, shea nut, soybean oil, sunflower oil and walnut oil.

A further source of fatty acid is tall oil. Tall oil is a mixture derived from wood. Normally crude tall oil contains resin acids (mainly abietic acid and its isomers), fatty acids (mainly palmitic acid, oleic acid and linoleic acid) and fatty alcohols, unsaponifiable sterols (5-10%), some sterols, and other hydrocarbon derivates. Tall oil fatty acid (TOFA) can be obtained from tall oil, which typically comprises a mixture of fatty acids.

In some embodiments, the fatty acid is TOFA (i.e. one or more fatty acids obtained from tall oil, for example a mixture comprising palmitic acid, oleic acid and oleic acid).

A common quality measure for tall oil is acid value. Acid value (or neutralization number or acid number or acidity) is the mass of potassium hydroxide (KOH) in milligrams that is required to neutralize one gram of chemical substance. The acid number is a measure of the number of carboxylic acid groups in a chemical compound, such as a fatty acid, or in a mixture of compounds. In a typical procedure, a known amount of sample dissolved in an organic solvent (often isopropanol) and titrated with a solution of alcoholic potassium hydroxide (KOH) of known concentration using phenolphthalein as a colour indicator. There are standard methods for determining the acid number, such as ASTM D 974 and DIN 51558 (for mineral oils, biodiesel), or specifically for biodiesel using the European Standard EN 14104 and ASTM D664 are both widely used worldwide.

In some embodiments, the tall oil fatty acid or tall oil fatty acid mixture used in the process of the present disclosure has an acid number of ≤150 mg KOH/g, >150 mg KOH/g, or >160 KOH/g, or >170 KOH/g, or >180 KOH/g, or >190 KOH/g, or >200 KOH/g, or >210 KOH/g, or >220 KOH/g. In some embodiments, the tall oil fatty acid or tall oil fatty acid mixture has an acid value in the range of from 165 to 175 mg KOH/g, or from 170 to 180 mg KOH/g, or from 175 to 185 mg KOH/g, or from 180 to 190 mg KOH/g, or from 185 to 195 mg KOH/g, or from 190 to 200 mg KOH/g, or from 195 to 205 mg KOH/g, or from 200 to 210 mg KOH/g, or from 205 to 215 mg KOH/g, or from 210 to 220 mg KOH/g, or from 215 to 225 mg KOH/g,

In some embodiments, the tall oil fatty acid or tall oil fatty acid mixture has a free rosin acid content of >0.5 wt. %, or >0.75 wt. %, or >1 wt. %, or 1.25 wt. %, or >1.5 wt. %, or >1.75 wt. %, or >2 wt. %, or >2.25 wt. %, or >2.5 wt. %, or >2.75 wt. %, or >3.0 wt. %, or >3 wt. %, or >3.25 wt. %, or >3.5 wt. %, or >3.5 wt. %, or >4 wt. %, or >5 wt. %, or >6 wt. %.

The tall oil fatty acid or tall oil fatty acid mixture can if desired be characterised by an iodine value. The iodine value (or iodine adsorption value or iodine number or iodine index) in chemistry is the mass of iodine in grams that is consumed by 100 grams of a chemical substance. Iodine numbers are often used to determine the amount of unsaturation in fatty acids. This unsaturation is in the form of double bonds, which react with iodine compounds. The higher the iodine number, the more C═C bonds are present in the fat.

In some embodiments, the tall oil fatty acid or tall oil fatty acid mixture has an iodine value of >30 g I/100 g, or >40 g I/100 g, or >50 g I/100 g, or >60 g I/100 g, or >70 g I/100 g, or >80 g I/100 g, or >90 g I/100 g, or >100 g I/100 g, or >110 g I/100 g, or >120 g I/100 g, or >130 g I/100 g, or >150 g I/100 g, or >160 g I/100 g, or >170 g I/100 g.

The tall oil fatty acid or tall oil fatty acid mixture can if desired be characterised by a saponification value. A saponification value number represents the number of milligrams of potassium hydroxide required to saponify 1 g of fat under the conditions specified. It is a measure of the average molecular weight (or chain length) of all the fatty acids present. As most of the mass of a fat/tri-ester is in the 3 fatty acids, the saponification value allows for comparison of the average fatty acid chain length. The long chain fatty acids found in fats have a low saponification value because they have a relatively fewer number of carboxylic functional groups per unit mass of the fat as compared to short chain fatty acids.

In some embodiments, the tall oil fatty acid or tall oil fatty acid mixture has saponification value of ≤140 mg KOH/g, >150 mg KOH/g, or >160 mm KOH/g, or >170 mm KOH/g, or >180 mm KOH/g, or >190 mm KOH/g, or >200 mm KOH/g, or >210 mm KOH/g, or >220 mm KOH/g. In some embodiments, the tall oil fatty acid or tall oil fatty acid mixture has a saponification value in the range of from 165 to 175 mg KOH/g, or from 170 to 180 mg KOH/g, or from 175 to 185 mg KOH/g, or from 180 to 190 mg KOH/g, or from 185 to 195 mg KOH/g, or from 190 to 200 mg KOH/g, or from 195 to 205 mg KOH/g, or from 200 to 210 mg KOH/g, or from 205 to 215 mg KOH/g, or from 210 to 220 mg KOH/g, or from 215 to 225 mg KOH/g,

The tall oil fatty acid or tall oil fatty acid mixture may also comprise an amount of unsaponified matter. In some embodiments, the tall oil fatty acid or tall oil fatty acid mixture comprises an amount of unsaponified matter of <20 w/w %, or <15 w/w %, or <12.5 w/w %, or <10 w/w %, or <7.5 w/w %, or <5 w/w %, or <4 w/w %, or <3 w/w %, or <2 w/w %, or <1 w/w %.

In some embodiments, the tall oil fatty acid or tall oil fatty acid mixture has a typical free fatty acid content of >60 wt. %, or >65 wt. %, or >70 wt. %, or >75 wt. %, or >80 wt. %, or >85 wt. %, or >90 wt. %, or >91 wt. %, or >92 wt. %, or >93 wt. %, or >94 wt. %, or >95 wt. %, or >97 wt. %, or >98 wt. %, or >99 wt. %.

In some embodiments, the tall oil fatty acid or tall oil fatty acid mixture has one or more of the following properties:
an acid value in the range of from 185 to 195 mg KOH/g; and
a rosin acid content of up to 4 wt %.

As discussed above, a mixture of fatty acids can be used, for example a mixture including oleic acid, linoleic acid and palmitic acid. In some embodiments, a mixture containing additional fatty acids may be used (for example a mixture containing oleic, palmitic and/or linoleic acid, and also containing one or more further fatty acids).

In some embodiments, the further fatty acid or acids contain up to 18 carbon atoms, up to 17 carbon atoms, up to 16 carbon atoms, up to 15 carbon atoms, up to 14 carbon atoms, up to 13 carbon atoms or up to 12 carbon atoms. In some embodiments, the further fatty acid or acids contain more than 4 carbons, more than 5 carbons, more than 6 carbons, more than 7 carbons, more than 8 carbons, more than 9 carbons, or more than 10 carbons. In some embodiments the further fatty acid or acids contain in the range of from 4 to 18 carbon atoms, or from 8 to 18 carbon atoms, or from 12 to 18 carbon atoms.

In some embodiments, the fatty acid is selected from the group consisting of one or more of FOR2 (supplier: Forchem OYJ), Emery Emersol 213 (supplier: Emery Oleo Chemicals LLC), Emery Emersol 221 (supplier: Emery Oleo Chemicals LLC), Emery Edenor C18-7OU (supplier: IMCD AU), FA1 (supplier: Kraton), FA2 (supplier: Kraton), Pinechem 110 (supplier: Lawter (N.Z.) Ltd.), SCPC L1-C Tall Oil Fatty Acid (supplier: Hexion Procurement), Wilfarin Oleic 6 (supplier: Wilmar), Wilfarin Oleic OA7075 (supplier: Wilmar), Wilfarin Oleic OA7070 (supplier: Wilmar), Univar 836229 (High IV Tall Oil) (supplier: Univar), Univar 826219 (Linoleic Acid Hi IV TOFA) (supplier: Univar), FAC OL75 (supplier: Marubeni), Oleic Acid 75%-OL-7519 (supplier: Marubeni), SINAR-OL75 (supplier: Marubeni), Lishan Dimer Acid LS-17 (supplier: Hexion Procurement), Oleic Acid LS-1 (supplier: Hexion Procurement), Alpyne L5, PALMAC 750.

In some embodiments, the fatty acid is Pinechem 110 (available from Lawter).

In some embodiments, the fatty acid (i.e. single fatty acid or mixture of fatty acids) is used in an amount in the range of from 70 to 700 grams per tonne of dry metal ore, or from 200 to 600 grams per tonne of dry metal ore, or from 300 to 500 grams per tonne of dry metal ore.

In some embodiments, flotation is carried out in the presence of an ether carboxylic acid surfactant. Without wishing to be bound by any particular theory, it is understood that the presence of an ether carboxylic acid surfactant enables the adequate formation of froth both in soft and hard water facilitating good separation of metal-containing mineral from waste metal ore components. Froth stability is an important factor in determining flotation yield. In addition, it is hypothesized that, when using an ether carboxylic acid surfactant in the flotation process as defined herein, it is possible to obtain smaller micelle sizes compared to a TOFA only formulation, promoting the flotation of small particles which make up most of the Li ores mass. The ether carboxylic acid surfactant may for example be selected based upon its selective wetting of the types of particles to be separated. The wetting activity of an ether carboxylic acid surfactant on a particle can be determined by for example measuring the contact angle that the liquid/bubble interface makes with it.

In some embodiments, the ether carboxylic acid surfactant is an alkyl or alkenyl ether carboxylic acid surfactant. In some embodiments, the ether carboxylic acid surfactant is an alkyl ether carboxylic acid surfactant. For example, the alkyl group may be a C₆ to C₂₀ alkyl group, or a C₈ to C₁₆ alkyl group, or a C₁₀ to C₁₄ alkyl group, or a C₁₂ alkyl group.

In some embodiments, the ether carboxylic acid surfactant is an alkenyl ether carboxylic acid surfactant. For example, the alkenyl group may be a C₆ to C₂₀ alkyl group, or a C₈ to C₁₆ alkenyl group, or a C₁₀ to C₁₄ alkenyl group, or a C₁₂ alkenyl group.

In some embodiments, the ether carboxylic acid surfactant is a polyoxyethylene alkyl ether carboxylic acid surfactant or a polyoxyethylene alkenyl ether carboxylic acid surfactant.

In some embodiments, the ether carboxylic acid surfactant is a polyoxyethylene alkyl ether carboxylic acid surfactant. In some embodiments, the polyoxyethylene alkyl ether carboxylic acid or salt thereof is of the formula:

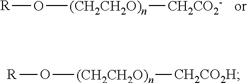

R is a C₆₋₂₀ alkyl group; and
n is an integer of from 2 to 100.

In some embodiments, R is a C₈ to C₁₆ alkyl group, or a C₁₀ to C₁₄ alkyl group, or a C₁₂ alkyl group.

In some embodiments, n is a integer of from 2 to 50 or from 2 to 20 or from 2 to 10, or from 2 to 5. In some embodiments, n is 2, 3, 4, 5, 6, 7, 8, 9 or 10.

In some embodiments, R is a C₁₀ to C₁₄ alkyl group, or a C₁₂ alkyl group; and n is an integer of from 2 to 5, e.g. n is 2, 3, 4 or 5. In some embodiments, R is C₁₂ alkyl and n is 3. In some embodiments, R is C₁₂ alkyl and n is 4.

In some embodiments, the ether carboxylic acid surfactant is a polyoxyethylene alkenyl ether carboxylic acid surfactant. In some embodiments, the polyoxyethylene alkenyl ether carboxylic acid or salt thereof is of the formula:

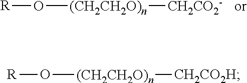

R is a C₆₋₂₀ alkenyl group; and
n is an integer of from 2 to 100.

In some embodiments, R is a C₈ to C₁₆ alkenyl group, or a C₁₀ to C₁₄ alkenyl group, or a C₁₂ alkenyl group.

In some embodiments, n is a integer of from 2 to 50 or from 2 to 20 or from 2 to 10, or from 2 to 5. In some embodiments, n is 2, 3, 4, 5, 6, 7, 8, 9 or 10.

The ether carboxylic acid surfactant may be provided in the form of a free acid, or as a salt, e.g. a sodium salt

Examples of ether carboxylic acid surfactants include laureth-2 carboxylic acid, laureth-3 carboxylic acid (also known as polyoxyethylene (3) lauryl ether carboxylic acid), laureth-4 carboxylic acid (also known as polyoxyethylene (4) lauryl ether carboxylic acid), laureth-5 carboxylic acid, laureth-6 carboxylic acid, laureth-7 carboxylic acid, laureth-8 carboxylic acid, laureth-9 carboxylic acid, laureth-10 carboxylic acid, sodium laureth-2 carboxylate, sodium laureth-3 carboxylate, sodium laureth-4 carboxylate, sodium laureth-5 carboxylate, sodium laureth-6 carboxylate, sodium laureth-7 carboxylate, sodium laureth-8 carboxylate, sodium laureth-9 carboxylate, sodium laureth-10 carboxylate, trideceth-3 carboxylic acid (also known as polyoxyethylene (3) tridecyl ether carboxylic acid), trideceth-4 carboxylic acid (also known as polyoxyethylene (4) tridecyl ether carboxylic acid), sodium trideceth-3 carboxylate, sodium trideceth-4 carboxylate, trideceth-7 carboxylic acid, sodium trideceth-7 carboxylate, trideceth-8 carboxylic acid, tetradeceth-3 carboxylic acid, tetradeceth-4 carboxylic acid, sodium tetradeceth-3 carboxylate, sodium tetradeceth-4 carboxylate, undeceth-3 carboxylic acid, undeceth-4 carboxylic acid, sodium undeceth-3 carboxylate, sodium undeceth-4 carboxylate, deceth-3 carboxylic acid, deceth-4 carboxylic acid, sodium deceth-3 carboxylate and sodium deceth-4 carboxylate,

In some embodiments, the alkyl ether carboxylic acid surfactant is selected from the group consisting of Akypo RLM 25 (supplier: KAO chemicals, Japan), Emulsogen CLA020 (supplier: Clariant, Switzerland), Emulsogen CLA030 (supplier: Clariant, Switzerland), and AEC-25 (supplier Jiangsu Zhongshan Chemical, China).

In some embodiments, the ether carboxylic acid surfactant is Akypo RLM 25 (supplier: KAO chemicals, Japan.

In some embodiments, the ether carboxylic acid surfactant is used in an amount in the range of from 15 to 300 grams per tonne of dry metal ore, or from 30 to 2000 grams per tonne of dry metal ore, or from 40 to 100 grams per tonne of dry metal ore.

Flotation may be carried using fatty acid and ether carboxylic acid surfactant in any suitable weight ratio, such as a weight ratio in the range of from about 50:50 to about 95:1, or from about 70:30 to about 95:5, optionally about 70:15.

In some embodiments, flotation is carried out in the presence of a fatty acid alkyl ester. Without being bound by any particular theory, it is understood that the fatty acid alkyl ester may function as a defoamer, which assists production of fragile bubbles/froth that easily break down after collection, hence avoiding the excessive accumulation of large volumes of froth for prolonged periods, e.g. once the fraction enriched in the flotable mineral has been separated. Thus, the fatty acid ester may assist in enabling simpler flotation process design, avoiding the need for large tanks to store froth and instead requiring relatively small tanks or containers for froth collection and breakdown.

Examples of fatty acid alkyl esters include methyl oleate, ethyl oleate, methyl stearate, ethyl stearate, methyl palmitate, ethyl palmitate, methyl linoleate and ethyl linoleate. In some embodiments, the fatty acid alkyl ester is methyl oleate.

A single fatty acid alkyl ester may be used, or a mixture of two, three or more, if desired. In some embodiments, the fatty acid alkyl ester is a biodiesel fatty acid alkyl ester or biodiesel fatty acid alkyl ester mixture. Biodiesel typically contains fatty acid alkyl esters, more particularly fatty acid methyl esters (FAME), and is mainly produced by transesterification vegetable oils and animal fats, and can be synthesized by chemical, enzymatic, or in vivo catalysis. The main components of biodiesel are methyl stearate, methyl palmitate, methyl oleate, and methyl linoleate.

In some embodiments, the fatty acid alkyl ester is used in an amount in the range of from 15 to 300 grams per tonne of dry metal ore, or from 30 to 2000 grams per tonne of dry metal ore, or from 40 to 100 grams per tonne of dry metal ore.

Flotation may be carried using fatty acid and fatty acid alkyl ester in any suitable weight ratio, such as a weight ratio in the range of from about 50:50 to about 95:1, or from about 70:30 to about 95:5, optionally about 70:15.

In some embodiments, flotation is carried out in the presence of a fatty acid comprising one or more of oleic acid, linoleic acid and palmitic acid, an ether carboxylic acid surfactant and a fatty acid alkyl ester.

Flotation may be carried using fatty acid, ether carboxylic acid surfactant and fatty acid alkyl ester in any suitable weight ratio, e.g. 50-90:5-25:5-25, such as about 70:15:15.

In some embodiments, the fatty acid and the ether carboxylic acid surfactant and/or fatty acid alkyl ester are added together in the form of a flotation collector composition. For example, a composition containing the fatty acid and ether carboxylic acid surfactant may be used, or a composition containing the fatty acid and fatty acid alkyl ester may be used, or a composition containing the fatty acid, ether carboxylic acid surfactant and fatty acid alkyl ester may be used.

In some embodiments, the flotation collector composition comprises from about 50 to about 90 wt % fatty acid, optionally from about 60 to about 80 wt %, optionally about 70 wt %.

In some embodiments, the flotation collector composition comprises from about 5 to about 30 wt % ether carboxylic acid surfactant, or from about 10 to about 20 wt % ether carboxylic acid surfactant, or about 15 wt % ether carboxylic acid surfactant.

In some embodiments, the flotation collector composition comprises from about 5 to about 30 wt % fatty acid alkyl ester, or from about 10 to about 20 wt % fatty acid alkyl ester, or about 15 wt % fatty acid alkyl ester.

Where the flotation collector composition contains each of a fatty acid, an ether carboxylic acid surfactant and a fatty acid alkyl ester, the flotation collector composition may contain the fatty acid, ether carboxylic acid surfactant and fatty acid alkyl ester in any suitable weight ratio, e.g. 50-90:5-25:5-25. In some embodiments, the weight ratio of fatty acid to surfactant to fatty acid alkyl ester is about 70:15:15.

In some embodiments, the flotation collector composition comprises from about 50 to about 90 wt % fatty acid, from about 5 to about 25 wt % ether carboxylic acid surfactant, and from about 5 to about 25 wt % fatty acid alkyl ester. In some embodiments, the flotation collector composition comprises about 70 wt % fatty acid, about 15 wt % ether carboxylic acid surfactant, and about 15 wt % fatty acid alkyl ester.

The flotation collector composition may be added at any suitable dosing rate, for example, in the range of from about 100 to about 1000 grams per tonne of dry ore, or from about 200 to about 800 grams per tonne of dry ore, or from about 250 to about 600 grams per tonne of dry ore, or from about 400 to about 500 grams per tonne of dry ore, In some embodiments, the flotation collector composition is added at a dosing rate of about 300 grams per tonne of dry ore, or about 350 grams per tonne of dry ore, or about 400 grams per tonne of dry ore, or about 450 grams per tonne of dry ore, or about 500 grams per tonne of dry ore, or about 550 grams per tonne of dry ore, or about 600 grams per tonne of dry ore, or about 650 grams per tonne of dry ore, or about 700 grams per tonne of dry ore, or about 750 grams per tonne of dry ore.

Flotation may if desired be carried out in the presence of one or more further additives and/or modifiers. In some embodiments, a frother is used in the flotation step. Frothers are compounds which facilitate formation of froth and can further assist flotation, particularly with respect to bubble size, and the stability and mobility of the froth phase. Frothers may for example in some embodiments be heteropolar surface-active compounds containing a polar group and a hydrocarbon radical. There are several different classifications of frothers depending on their properties and behaviours. Four classification methods commonly used are based on pH-sensitivity, solubility, frothing/collecting ability, and selectivity/frothing-power relationship. Examples of acidic frothers include phenols and alkyl sulfonates. Examples of neutral frothers include aliphatic alcohols (such as methyl isobutyl carbinol (MIBC), or 4-methyl-2-pentanol, a branched-chain aliphatic alcohol, or 2-ethyl hexanol (4-heptanol)), cyclic alcohols and natural oils, alkoxy paraffins, polypropylene glycol ethers, including C₁₋₄ alkyl ethers of polypropylene glycol, polyglycol ethers and polyglycol glycerol ethers. Examples of basic frothers include pyridine and homologs, which are generally recovered as byproducts from coal tar distillation.

In some embodiments, flotation is conducted in the presence of a polypropylene glycol. Polypropylene glycols are versatile and can give a wide range of froth properties.

Examples of frothers include alcohols, such as MIBC (methyl isobutyl carbinol, or 4-methyl-2-pentanol, a branched-chain aliphatic alcohol) or a polypropylene glycol.

In some embodiments, the fatty acid, ether carboxylic acid surfactant and/or fatty acid alkyl ester, and frother, are added together in the form of a flotation collector composition. In some embodiments, the flotation collector composition comprises from about 1 to about 8 wt % frother, optionally about 4 wt %.

In some embodiments, no frother is used.

In some embodiments, following separation of the first fraction from the second fraction, the first fraction is subjected to one or more further processing and/or purification steps. For example, a fraction enriched in the flotable mineral may be allowed to stand so that foam dissipates or decreases, and/or it may be subject to a step to separate the flotable mineral from liquid components of the fraction enriched in the mineral. For example, a decanting, siphoning and/or filtration step may be carried out. The material may if desired be subject to a drying step. For example, in some embodiments, drying is conducted using a rotary dryer.

Flotation produces a fraction enriched in the flotable mineral. The weight ratio of flotable mineral to waste ore components (non-desired components from the ore) is greater in the fraction enriched in the flotable mineral than in the ore that is subjected to flotation. Accordingly, there is also provided an ore fraction enriched in flotable mineral obtained by a process as defined herein. There is also provided a flotable mineral obtained by a process as defined herein. There is also provided an ore fraction enriched in spodumene obtained by a process as defined herein. There is also provided spodumene obtained by a process as defined herein.

Where the flotable mineral is a metal-containing mineral, the fraction enriched in metal-containing mineral can, if desired, be subjected to one or more further steps to obtain the metal from the mineral, e.g. in the form of a salt such as carbonate or as a hydroxide.

Accordingly, in some embodiments, the flotable mineral is spodumene and, following separation of the fraction enriched in spodumene, lithium present in spodumene is obtained by conversion of the spodumene into lithium carbonate or lithium hydroxide.

In the case of spodumene, typically lithium carbonate or lithium hydroxide is obtained from spodumene. For example, dried spodumene may be subjected to calcination (e.g. in a rotary kiln), which converts alpha spodumene to beta spodumene. The obtained beta spodumene may then if desired be treated with sulfuric acid, known as sulfuric acid digestion (for example using a paddle or pugmill mixer). An acid roasting step is commonly carried out following treatment with sulfuric acid, typically using a rotary kiln. This results in the production of lithium sulfate, which can be converted to either lithium carbonate or lithium hydroxide, e.g. by a hydrometallurgical process.

Accordingly, in another aspect, there is provided lithium carbonate or lithium hydroxide obtained by a process as defined herein.

### Flotation Collector Compositions,

The process of the present disclosure involves, in some embodiments, the use of a flotation collector composition, which provides for good recovery of flotable minerals such as the lithium-containing mineral spodumene.

Thus, in another aspect, there is provided a flotation collector composition comprising:
i) a fatty acid comprising one or more of oleic acid, linoleic acid and palmitic acid; and
ii) an ether carboxylic acid surfactant, and/or a fatty acid alkyl ester.

In some embodiments, the flotation collector composition may comprise a frother.

Embodiments described above in relation to the process for the fatty acid, ether carboxylic acid surfactant, fatty acid alkyl ester, and where used the frother, and their relative amounts and ratios, also apply to the flotation collector composition.

### Additive Compositions and Kits

It may be convenient to prepare a flotation collector composition shortly prior to use, e.g. by combining the fatty acid component (such as TOFA) with a composition containing an ether carboxylic acid surfactant and a fatty acid ester. Thus, in another aspect, there is provided an additive composition for producing a flotation collector composition, comprising:
an ether carboxylic acid surfactant; and
a fatty acid alkyl ester.

Embodiments described above in relation to the process for the ether carboxylic acid surfactant and fatty acid alkyl ester, and their relative amounts and ratios, also apply to the additive composition.

It may be convenient to add the fatty acid and ether carboxylic acid surfactant and/or fatty acid alkyl ester directly in the flotation step, or as discussed above it may be desirable to make up a floatation collector composition just prior to use. Thus, in some cases, it may be advantageous to have access to a kit comprising the chemicals for use in flotation.

Accordingly, in another aspect, there is provided a kit for producing a flotation collector composition, comprising:
a) a fatty acid comprising one or more of oleic acid, linoleic acid and palmitic acid; and one or both of
b) an ether carboxylic acid surfactant; and
b1) a fatty acid alkyl ester.

In some embodiments, the kit comprises a frother.

Embodiments described above in relation to the process for the fatty acid, ether carboxylic acid surfactant, fatty acid alkyl ester, and where used the frother, and their relative amounts and ratios, also apply to the kit.

Those skilled in the art will appreciate that the disclosure herein is susceptible to variations and modifications other than those specifically described. It is to be understood that the disclosure includes all such variations and modifications.

### EXAMPLES

The present disclosure is further illustrated by the following non-limiting examples.

### Example 1—General Preparation of Flotation Collector Composition

1. A stock of fatty acid is weighed and added to a suitable container.
2. To prepare a certain mass of the formulation, an ether carboxylic acid surfactant and optionally a fatty acid alkyl ester is added to the fatty acid at ambient temperature.
3. The blend is stirred for 10 minutes such that a homogenous and clear solution is formed.
4. The formulation is then stored at ambient temperature in a tight-close plastic container.

### Example 2—Evaluation of Flotation Collector Compositions

Flotation collector compositions were prepared and tested for their properties in recovery of spodumene from ore samples.

### Compositions

The compositions tested were:

### Composition A

TOFA (Pinechem 110, available from Lawter) (70% by weight);
polyoxyethylene (3) lauryl ether carboxylic acid (AKYPO RLM25, available from Kao Global Chemicals, Japan) (30% by weight).

### Composition B

TOFA (Pinechem 110, available from Lawter) (70% by weight);
Alkyl ether carboxylic acid surfactant (AEC-25, Jiangsu Zhongshan Chemical, China) (30% by weight).

The compositions were prepared in accordance with Example 1.

### Raw Materials

TABLE 1
Raw materials used in the Flotation process

| Raw materials | Description |
|---|---|
| Pinechem ™ 110, available from | Tall Oil Fatty Acid |
| Lawter (properties of Pinechem ™ | |
| 110 are listed in Table 1) | |
| Akypo RLM 25 | Alkyl Ether Carboxylic |
| | Acid Surfactant |
| AEC-25 | Alkyl Ether Carboxylic |
| | Acid Surfactant |
| 20% Sodium Carbonate | pH regulator |
| Defoamer H57 | Control foam |
| Diesel | Control foam |

TABLE 2
Typical Properties for Pinechem ™ 110

| Property | Value | Test Method/Standard |
|---|---|---|
| Acid Value (mg KOH/g) | 189 Min | Titration |
| Rosin Acid Content (%) | 3 Max | Titration |
| Colour | 5 Max | Gardner |
| Viscosity | A-2 | Gardner Holdt (25° C.) |
| Viscosity (cPs) ° C. | 20 | |

### Experimental Design

Altura feed stock was used having an average size of approximately ˜170 μm and 1.1% LiO₂ of the pure Spodumene (pure Spodumene has ˜8.1% of LiO₂).

Melbourne tap water was used for all flotation processes in Example 2 and conditioned at pH 8 with sodium carbonate as a pH regulator. A small amount of diesel and defoamer was used to control the foam. The air and agitation speed was kept constant and all testing preformed at ambient temperature.

Each float stage was sent to an independent Metallurgical Laboratory to determine the level of LiO₂, Al₂O₃, CaO, Fe₂O₃, K₂O, MnO, P₂O₅, SiO₂, TiO₂ via Inductively Coupled Plasma Spectroscopy (ICP).

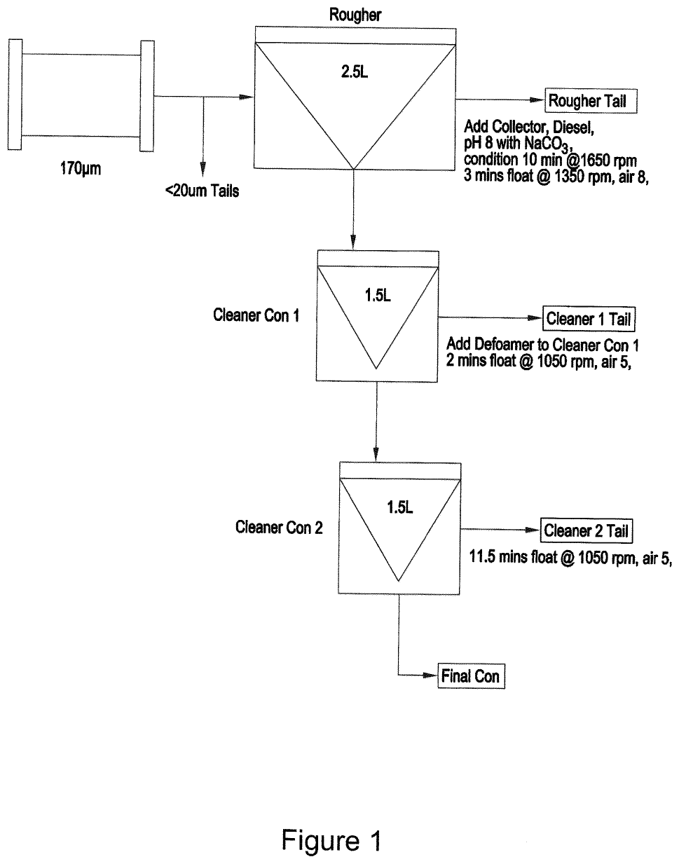

A three stage cleaner flotation process was used for the experiments (see FIG. 1)

### Conditioning and pH Adjustment

A 2.5 L float cell was selected and set up to a Denver D-12 Flotation machine with the impeller set to the lower position. A pre-weight sample of 1200 g of Altura feed stock was transferred into a 2.5 L float cell with tap water filled up ½ of the cell. An appropriate amount of collector was added to the Rougher and conditioned for 10 minutes at 1650 rpm. The collector levels assessed were 1040 g/t and 660 g/t. Diesel was added, only to the higher level of collector (1040 g/t). During conditioning, pH was adjusted to 8.0 with 20% sodium carbonate.

### Collecting the Cleaner Concentrate Fractions

The 2.5 L float cell containing the condition slurry was filled to ˜1 inch below the cell lip with tap water. The agitation speed was reduced to 1350 rpm and the air was set to 8. The Cleaner Con 1 fraction was floated for 3 minutes and collected into a plastic tub (size 25×18×15 cm) using a fabricated plastic L shape scraper. The air and speed were turned off and the impeller was lifted up via pulling a height adjustment stop pin on the right-hand side and rotating the left-hand side handle and lock in again with the pin. The 2.5 L cell consisting of the Rougher Tail was remove and ready to be filtered

Depending on the level of foam in the Cleaner Con 1 tub, various small amount of defoamer was added and mixed to reduce the foam prior transferring into a 1.5 L float cell. Any remaining residue in the tub was washed, cleaned using a squeezy water bottle and transferred into the 1.5 L cell. The 1.5 L cell was placed under the impeller and the impeller was adjusted to the lowest position. The cell was filled with water, 1 inch below the cell lip. The agitation and air were turn on and set to 1050 rpm and level 5 respectively. The Cleaner Con 2 was float and the foam was collected into a 35×24×7 cm tray for 2 minutes. The impeller was adjusted to the higher position and the 1.5 L cell consisting of Cleaner 1 Tail was removed and filtered.

The tray consisting of the Cleaner Con 2 was transferred into a clean 1.5 L float cell and set in place below the impeller. The impeller was adjusted to the lowest position and water was filled to 1 inch below the cell lip. The agitation and air were turn on and set to 1050 rpm and level 5 respectively. The Final Con fraction was float and collected into a 35×24×7 cm tray for 1.5 minute. The impeller was adjusted to the higher position and the 1.5 L cell consisting of Cleaner 2 Tail was removed and filtered.

Further details of the testing conditions are set out in FIG. 1 and Table 3.

TABLE 3
Flotation Test Sheet for Three Stage Cleaner
Process with 660 and 1040 g/t of Collector

| | Collector | Condition | Float | | Diesel | | | |
|---|---|---|---|---|---|---|---|---|
| | Level | Time | Time | | Level | Air | Deformer | Speed |
| Operation | (g/t) | (min) | (min) | pH | (ml) | Level | Level | (rpm) |
| Condition 1 | 1040 | 10 | | 8 | 0.25 | | | 1650 |
| Rougher 1 | | | 3 | | | 8 | | 1350 |
| Cleaner Con 1 | | | 2 | | | 5 | 4 drops | 1050 |
| Cleaner Con 2 | | | 1.5 | | | 5 | | 1050 |
| Condition 1 | 660 | 10 | | 8 | | | | 1650 |
| Rougher 1 | | | 3 | | | 8 | | 1350 |
| Cleaner Con 1 | | | 2 | | | 5 | | 1050 |
| Cleaner Con 2 | | | 1.5 | | | 5 | | 1050 |

Each froth fraction collected (Cleaner 1 Tail, Cleaner 2 tail and Final Con) and the Rougher Tail, was filtered using the Laboratory Pressure Filter.

### Filtering and Drying

Each fraction collected was filtered using the laboratory pressure filter. A pre-dry and weight Wet Strength Filter paper (code MN722-33 cm diameter, particle retention of 7-12 microns) was placed on top of a white non-woven pad and between the bottom seal plate and filter chamber. The bottom filter lid was rosed up and tighten to the filter chamber via the rotating the bottom Filter-box handle clockwise. The Froth fraction collected was transferred into the filter chamber and the float cell (or plastic tub/tray) and the internal side of the chamber was clean with a 5 L spray water bottle. The top filter lid was closed and tighten via turning the filter-box handle clockwise. The air was turned on and fill the filter chamber. The liquid inside the filter chamber was empty and drained through the discharge pipe. The air was turned off and empty from the filter chamber. The top filter lid was opened and inspected for any liquid remaining before the bottom filter lid was lower to an appropriate position to remove the non-woven pad with filter cake. Transferred the filter paper with the filter cake into a 15.7×22×4.7 cm aluminium tray and dried in the oven at 105° C. until dry (note: The Rougher Tail sample would require longer time to dry).

The dried filter cake was cooled to room temperature and weighed on a two-decimal balance. Approximately about ≤170 g of the filter cake was transferred into a 72×145 mm Wet-strength Brown Kraft Paper sample bag and seal by folding the opening and secure/tied back with the wire. The float samples were sent to a Mineralogical Laboratory for Lithium analysis.

### Results

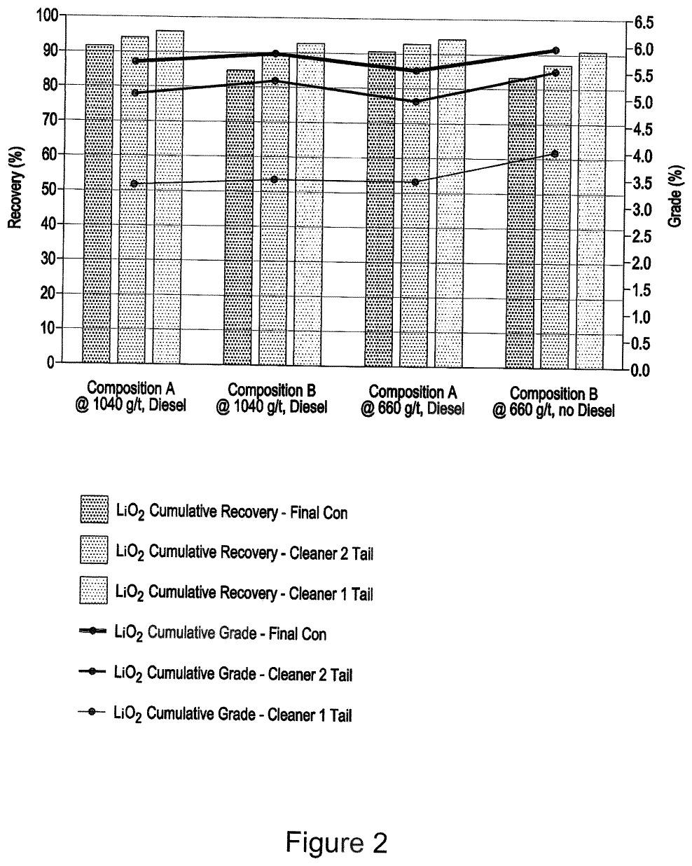

Collector samples obtained using both Compositions A and B gave good levels of LiO₂ recovery. Final Concentrate collector samples obtained using Composition A gave ˜7-9% higher LiO₂ recovery than collector samples obtained using Composition B. However, there was ˜3-7% increase in the LiO₂ grade for Final Concentrate collector samples obtained using Composition B compared with Composition A. The results are summarised in Table 4 below. FIG. 2 also shows a graph of LiO₂ cumulative recovery/grade for samples obtained using Compositions A and B. The ratio of LiO₂ grade to recovery is also set out in Table 5.

TABLE 4
LiO₂ cumulative recovery/grade of Compositions A and B

| | | LiO₂ Cumulative Recovery (%) | | | LiO₂ Cumulative Grade (%) | | |
|---|---|---|---|---|---|---|---|
| | Collector | Final | Cleaner | Cleaner | Final | Cleaner | Cleaner |
| Collector | Level g/t | Con | 2 Tail | 1 Tail | Con | 2 Tail | 1 Tail |
| Composition A | 1040 | 91.6 | 94.0 | 95.7 | 5.64 | 5.07 | 3.37 |
| Composition B | 1040 | 84.9 | 88.8 | 92.6 | 5.81 | 5.34 | 3.47 |
| Composition A | 660 | 90.4 | 92.6 | 94.2 | 5.51 | 4.96 | 3.46 |
| Composition B | 660 | 83.5 | 86.9 | 90.9 | 5.93 | 5.51 | 4.02 |

TABLE 5
LiO₂ Ratio of Grade:Recovery

LiO₂ Ratio of Grade:Recovery

| | Collector | Final | Cleaner | Cleaner |
|---|---|---|---|---|
| Collector | Level g/t | Con | 2 Tail | 1 Tail |
| Composition A | 1040 | 0.062 | 0.054 | 0.035 |
| Composition B | 1040 | 0.068 | 0.060 | 0.037 |
| Composition A | 660 | 0.061 | 0.054 | 0.037 |
| Composition B | 660 | 0.072 | 0.063 | 0.039 |

### CONCLUSION

Both Compositions A and B perform very well as flotation collector compositions, demonstrating slightly different properties in terms of levels of LiO₂ recovery versus LiO₂ grade.

### Example 3—Evaluation of Further Flotation Collector Composition

A flotation collector composition (Composition C) was prepared using tall oil fatty acid (TOFA) (Pinechem™ 110, available from Lawter), polyoxyethylene (3) lauryl ether carboxylic acid (AKYPO RLM25, available from Kao Global Chemicals, Japan) as the surfactant, and methyl oleate (Trilube 118, available from Tritech) as a fatty acid alkyl ester in accordance with Example 1. The amounts of the composition components were as follows:
TOFA (70% by weight),
polyoxyethylene (3) lauryl ether carboxylic acid (15% by weight),
methyl oleate (15% by weight).
   Experiments were conducted to evaluate the properties of Composition C as a flotation collector composition for recovery of spodumene from ore samples.

Spodumene-containing ore samples from a Western Australia mine site were analysed.

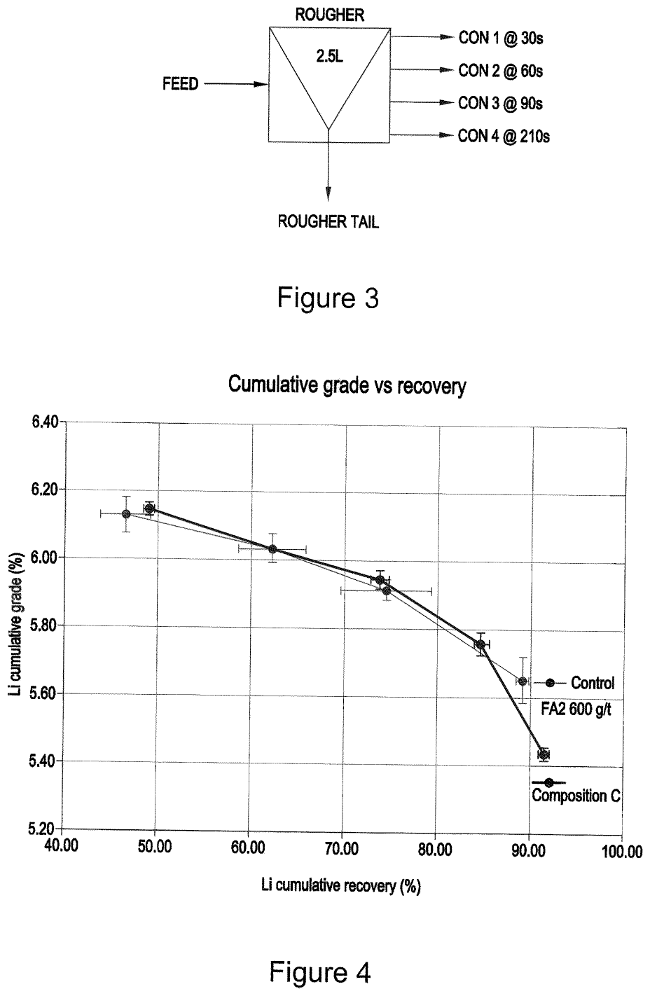

The flotation process experiments included a rougher step (See schematic FIG. 3),

A standard flotation cell was used with a volumetric capacity of 1 to 2.5 liters, 1 to 10 L/min air flow, and 500 to 1500 rpm impeller. Cell volume was 2.5 L, impeller speed was set at 1250 and then 1150 rpm, pH was 8.0, with addition of flotation collector composition, filtration of concentrates and analysis by elemental analysis method. Sampling time for the rougher step was at 30, 60, 90, 210 seconds.

Flotation performance was evaluated by analyzing the dry mass and elemental composition of all flotation outputs to calculate the grades and recoveries of final concentrates. In addition, froth volumes and mass pulls were recorded as these parameters need to be within certain specifications dictated by the design of the mining plant.

All experiments were performed in triplicate to generate statistical significance.

The aim was to maximize the grade and recovery using a low dose rate whilst obtaining an acceptable froth volume and mass pull.

Variables were the addition of collectors and the dose rate. The flotation experiments compared the flotation collector composition of Example 2 with a 100% TOFA composition (FA2, Sylfat™)

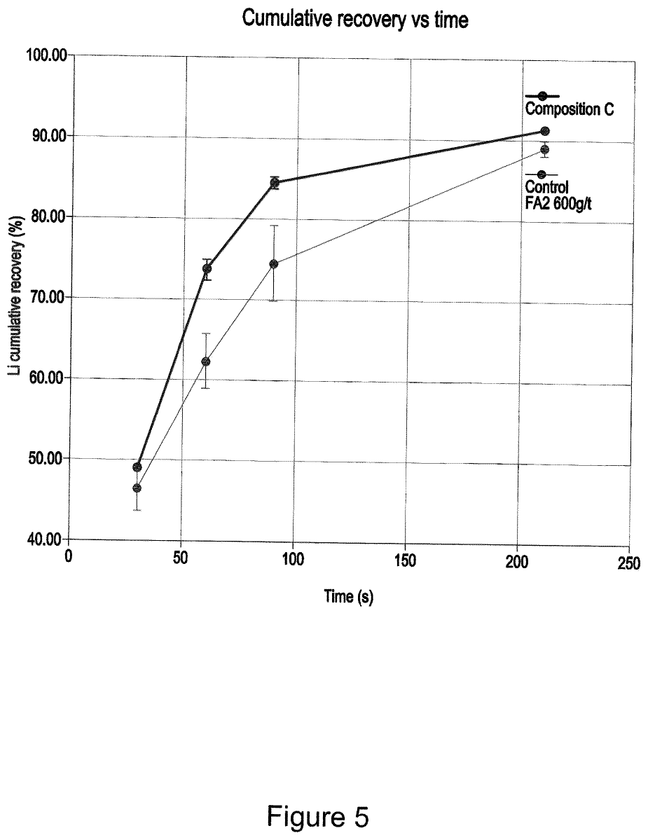

FA2 (Sylfat™) was used as baseline with a dose rate of 600 g/t. In contrast, Composition C was dosed at 450 g/t. The results of these experiments are plotted in FIG. 4 and FIG. 5, showing Li cumulative grade (%) vs Li cumulative recovery (%), and Li cumulative recovery (%) vs time(s).

FIG. 4 shows that comparable recovery and grade of lithium was achieved with Composition C within the standard deviation, despite only being dosed at 450 g/ton compared with the TOFA composition dosed at 600 g/ton.

FIG. 5 also shows that the recovery of Li-ores occurs at a faster rate using Composition C compared to FA2, thus providing the possibility of floating a higher mass flow, generating an increased Li-ore concentrate throughput.

Additional experiments were performed using a rougher step only at 600 g/ton of Composition C. Comparative results at 450 g/ton and 600 g/ton are shown in Table 6 below:

TABLE 6
Results from dosing experiments

| | | Cumulative | Cumulative |
|---|---|---|---|
| Experiment | Dosage | Li₂O % grade | Li₂O recovery |
| Name | amount | at 210 s | at 210 s |
| PPT09 | 450 g/t | 5.38 | 91.6 |
| PPT14 | 450 g/t | 5.46 | 91.4 |
| PPT15 | 600 g/t | 5.80 | 89.6 |

The results demonstrate that inclusion of the flotation collector composition at a higher dosage rate facilitates recovery of higher grade lithium.

### Example 4—Use of Flotation Collector Composition in Process for Obtaining Spodumene from Ore Samples

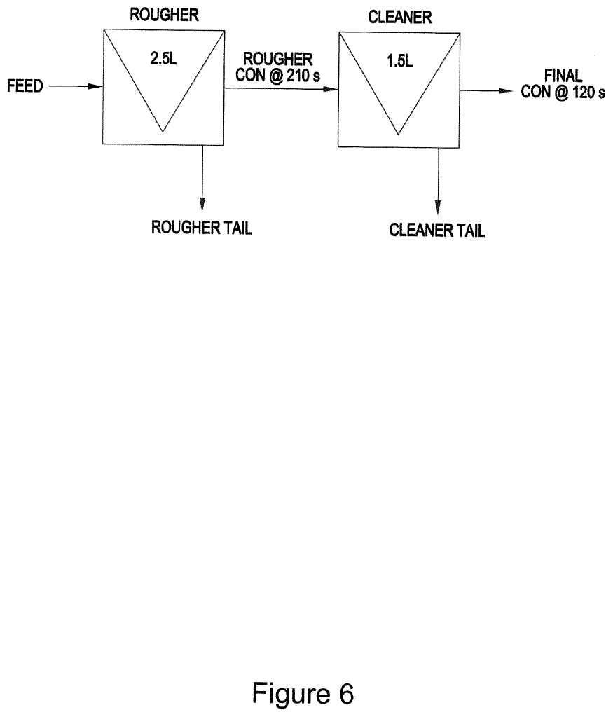

Flotation experiments comparing FA2 (Sylfat™) and Composition C were carried out using a flotation process design involving two different steps; a rougher step that aimed to maximize the recovery of Li-ores from the initial feed, and a cleaner step that aimed to maximize the recovery from the rougher concentrate (See schematic FIG. 6).

Spodumene-containing ore samples from a Western Australia mine site were analysed.

A standard flotation cell was used with a volumetric capacity of 1 to 2.5 litres, 1 to 10 L/min air flow, and 500 to 1500 rpm impeller. Cell volume was 2.5 L, impeller speed was set at 1250 and then 1150 rpm, the pH was 8.0, with addition of flotation collector compositions, filtration of concentrates and analysis by elemental analysis method. The combined rougher concentrate after 210 seconds was passed to the cleaner step which was sampled after 120 seconds.

Flotation performance was evaluated by analyzing the dry mass and elemental composition of all flotation outputs to calculate the grades and recoveries of final concentrates. In addition, froth volumes and mass pulls were recorded as these parameters need to be within certain specifications dictated by the design of the mining plant.

All experiments were performed in triplicate to generate statistical significance.

Variables were the addition of collectors and the dose rate. The flotation experiments compared Composition C with a 100% TOFA composition (FA2, Sylfat™)

FA2 (Sylfat™) was used as baseline with a dose rate of 600 g/t. In contrast, Composition C was dosed at a lower level of 450 g/t.

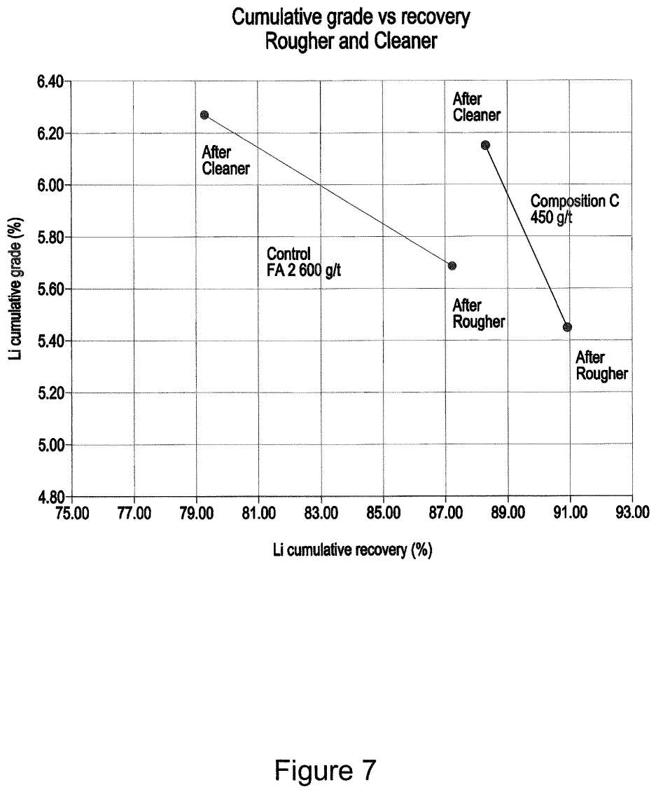

The results are plotted in FIG. 7. These data show that a final concentrate after rougher and cleaner steps using Composition C has a similar grade to concentrate produced using FA2, but has a much higher recovery of an additional 8%. Composition C thus provides an increased throughput of net final concentrate, despite being dosed at lower levels.

1.-80. (canceled)

81. A process for treating an ore, comprising:
subjecting an ore containing a flotable mineral to flotation; and subsequently separating a first fraction enriched in the flotable mineral from a second fraction containing waste ore components,
wherein flotation is carried out in the presence of:
i) a fatty acid or fatty acid mixture comprising one or more of oleic acid, linoleic acid and palmitic acid;
ii) an ether carboxylic acid surfactant or salt thereof, and
iii) a fatty acid alkyl ester.

82. A process as claimed in claim 81, wherein the fatty acid or fatty acid mixture is a tall oil fatty acid or tall oil fatty acid mixture.

83. A process as claimed in claim 82, wherein the tall oil fatty acid or tall oil fatty acid mixture has one or more of the following properties:
an acid value in the range of from 185 to 195 mg KOH/g; and
a rosin acid content of up to 4 wt %.

84. A process as claimed in claim 81, wherein the ether carboxylic acid surfactant or salt thereof is an alkyl ether carboxylic acid surfactant or salt thereof, optionally wherein the alkyl ether carboxylic acid surfactant or salt thereof is a polyoxyethylene alkyl ether carboxylic acid surfactant or salt thereof.

85. A process as claimed in claim 84, wherein the polyoxyethylene alkyl ether carboxylic acid or salt thereof is of the formula 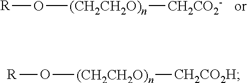
R is a C₆₋₂₀ alkyl group; and
n is an integer of from 2 to 100.

86. A process as claimed in claim 81, wherein the surfactant is selected from the group consisting of Akypo RLM 25, Emulsogen CLA020, Emulsogen CLA030, and AEC-25.

87. A process as claimed in claim 81, wherein the fatty acid alkyl ester is a biodiesel fatty acid alkyl ester or biodiesel fatty acid alkyl ester mixture.

88. A process as claimed in claim 87, wherein the fatty acid alkyl ester is methyl oleate.

89. A process as claimed in claim 81, wherein the fatty acid or fatty acid mixture, ether carboxylic acid surfactant or salt thereof and fatty acid alkyl ester are added together in the form of a flotation collector composition, optionally wherein the flotation collector composition comprises one or more of the following:
i) from about 60 wt % to about 80 wt % fatty acid or fatty acid mixture, optionally about 70 wt %;
ii) from about 5 wt % to about 30 wt % ether carboxylic acid surfactant or salt thereof, optionally about 15 wt %;
iii) from about 5 to about 30 wt % fatty acid alkyl ester, optionally about 15 wt %.

90. A process as claimed in claim 89, wherein one or both of the following applies:
i. the weight ratio of fatty acid or fatty acid mixture to ether carboxylic acid surfactant or salt thereof is in the range of from about 70:30 to about 95:5, optionally about 70:15.
ii) the weight ratio of fatty acid or fatty acid mixture to fatty acid alkyl ester is in the range of from about 70:30 to about 95:5, optionally about 70:15; and
iii) the weight ratio of fatty acid or fatty acid mixture to ether carboxylic acid surfactant or salt thereof to fatty acid alkyl ester is about 70:15:15.

91. A process as claimed in claim 81, wherein flotation is carried out in the presence of a frother, optionally wherein the frother is an aliphatic alcohol or a polyether, optionally wherein the frother is methyl isobutyl carbinol (MIBC), 4-methyl-2-pentanol, or polypropylene glycol.

92. A process as claimed in claim 91, wherein the flotable mineral is a lithium-containing mineral.

93. A process as claimed in claim 92, wherein the metal-containing mineral is spodumene.

94. A process as claimed in claim 81, wherein the flotable mineral is a rare earth metal-containing mineral.

95. A process as claimed in claim 89, wherein the flotation collector composition is added at a dosing rate in the range of from about 250 to about 600 grams per tonne of dry ore, optionally from about 400 to 500 grams per tonne of dry ore.

96. A process as claimed in claim 81 wherein, following separation of the first fraction from the second fraction, the first fraction is subjected to one or more further processing and/or purification steps.

97. A process as claimed in claim 81, wherein following separation of the first fraction from the second fraction, the first fraction is subjected to a further flotation and separation step to produce a fraction which is further enriched in the flotable mineral, wherein the further flotation step is carried out in the presence of:
i) a fatty acid or fatty acid mixture comprising one or more of oleic acid, linoleic acid and palmitic acid;
ii) an ether carboxylic acid surfactant or salt thereof, and
iii) a fatty acid alkyl ester.

98. A flotable mineral obtained by a process according to claim 81.

99. A process as claimed in claim 81, wherein the flotable mineral is spodumene and, following separation of the fraction enriched in spodumene, lithium present in spodumene is obtained by conversion of the spodumene into lithium carbonate or lithium hydroxide.

100. Lithium carbonate or lithium hydroxide obtained by a process according to claim 99.

101. A flotation collector composition comprising:
i) a fatty acid or fatty acid mixture comprising one or more of oleic acid, linoleic acid and palmitic acid;
ii) an ether carboxylic acid surfactant or salt thereof; and
iii) a fatty acid alkyl ester.

102. An additive composition when used for producing a flotation collector composition according to claim 101, comprising:
an ether carboxylic acid surfactant or salt thereof; and
a fatty acid alkyl ester.

103. A flotation collector composition as claimed in claim 101, wherein the fatty acid or fatty acid mixture is a tall oil fatty acid or tall oil fatty acid mixture.

104. A flotation collector composition as claimed in claim 103, wherein the tall oil fatty acid or tall oil fatty acid mixture has one or more of the following properties:
an acid value in the range of from 185 to 195 mg KOH/g; and
a rosin acid content of up to 4 wt %.

105. A flotation collector composition or additive composition as claimed in claim 101, or wherein the ether carboxylic acid surfactant or salt thereof is an alkyl ether carboxylic acid surfactant or salt thereof, optionally wherein the alkyl ether carboxylic acid surfactant or salt thereof is a polyoxyethylene alkyl ether carboxylic acid surfactant or salt thereof.

106. A flotation collector composition or additive composition as claimed in claim 105, wherein the polyoxyethylene alkyl ether carboxylic acid or salt thereof is of the formula 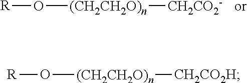
R is a C₆₋₂₀ alkyl group; and
n is an integer of from 2 to 100.

107. A flotation collector composition or additive composition as claimed in claim 101, wherein the surfactant is selected from the group consisting of Akypo RLM 25, Emulsogen CLA020, Emulsogen CLA030, and AEC-25.

108. A flotation collector composition or additive composition as claimed in claim 101, wherein the fatty acid alkyl ester is a biodiesel fatty acid alkyl ester or biodiesel fatty acid alkyl ester mixture.

109. A flotation collector composition or additive composition as claimed in claim 101, wherein the fatty acid alkyl ester is methyl oleate.

110. A flotation collector composition as claimed in claim 101, wherein one or more of the following applies:
i) the flotation collector composition comprises from about 50 to about 90 wt % fatty acid or fatty acid mixture, optionally from about 60 to about 80 wt %, optionally about 70 wt %;
ii) the weight ratio of fatty acid or fatty acid mixture to ether carboxylic acid surfactant or salt thereof is in the range of from about 70:30 to about 95:5, optionally about 70:15;
iii) the weight ratio of fatty acid or fatty acid mixture to fatty acid alkyl ester is in the range of from about 70:30 to about 95:5, optionally about 70:15;
iv) the weight ratio of fatty acid or fatty acid mixture to ether carboxylic acid surfactant or salt thereof to fatty acid alkyl ester is about 70:15:15;
v) the flotation collector composition comprises from about 5 to about 30 wt % ether carboxylic acid surfactant or salt thereof, optionally about 15 wt %;
vi) the flotation collector composition comprises from about 5 to about 30 wt % fatty acid alkyl ester, optionally about 15 wt %.
